(19) United States
(12) Patent Application Publication
(10) Pub. No.: US 2017/0129257 A1
(43) Pub. Date: May 11, 2017

(54) METALLIC DECORATION METHOD AND METALLIC DECORATION APPARATUS

(71) Applicant: MIMAKI ENGINEERING CO., LTD., NAGANO (JP)

(72) Inventors: AYUMI SAKAGUCHI, NAGANO (JP); MASARU OHNISHI, NAGANO (JP)

(73) Assignee: MIMAKI ENGINEERING CO., LTD., NAGANO (JP)

(21) Appl. No.: 15/343,218

(22) Filed: Nov. 4, 2016

(30) Foreign Application Priority Data
Nov. 5, 2015 (JP) 2015-217654

(51) Int. Cl. B41J 11/00

(52) U.S. Cl. CPC B41J 11/002

(57) ABSTRACT

A metallic decoration method of decorating decoration objects with decoration ink containing a silver β-ketocarboxylate is shown. This metallic decoration method includes a printing process of performing printing on a decoration object 1 by ejecting decoration ink made by diluting a silver β-ketocarboxylate with a solvent from an inkjet head 11, and a heating process of heating the decoration object 1 after the printing process, thereby vaporizing the solvent while decomposing the silver β-ketocarboxylate into metallic silver, thereby forming a metallic decoration layer 2, and in the printing process, printing is performed on the decoration object 1 while the decoration object 1 is heated. In this metallic decoration method, a heating temperature of the decoration object 1 in the heating process is set so as to be equal to or higher than a heating temperature of the decoration object 1 in the printing process.

### CROSS-REFERENCE TO RELATED APPLICATION

This application claims the priority benefit of Japan application serial no. 2015-217654, filed on Nov. 5, 2015. The entirety of the above-mentioned patent application is hereby incorporated by reference herein and made a part of this specification.

### BACKGROUND OF THE INVENTION

1. Technical Field

The present invention relates to a metallic decoration method for producing a decoration object having metallic luster. Also, the present invention relates to a metallic decoration apparatus for decorating a decoration object by the metallic decoration method.

2. Related Art

There have been known inkjet recording methods capable of producing records having metallic luster (see Japanese Patent Application Laid-Open No. 2011-149028 for instance). A recording method disclosed in Japanese Patent Application Laid-Open No. 2011-149028 uses ink containing metal foil flakes, an organic solvent, and a fixing resin. Also, there has been known ink containing a silver β-ketocarboxylate (see Japanese Patent Application Laid-Open No. 2009-197133 for instance). The silver β-ketocarboxylate contained in the ink disclosed in Japanese Patent Application Laid-Open No. 2009-197133 has an excellent property that it is rapidly decomposed into metallic silver even if it is heated at a low temperature equal to or lower than about 210° C.

According to the inkjet recording method disclosed in Japanese Patent Application Laid-Open No. 2011-149028, it is possible to generate records having metallic luster. However, according to examination of the inventor of this application, it is difficult to generate records having metallic luster like mirror surfaces. For this reason, the inventor of this application had examined a metallic decoration method for forming metallic decoration layers having metallic luster like mirror surfaces on decoration objects. As a result, the inventor of this application found out that it is possible to form metallic decoration layers having metallic luster like mirror surfaces on decoration objects by performing printing on the decoration objects with ink containing a silver β-ketocarboxylate as disclosed in Japanese Patent Application Laid-Open No. 2009-197133.

### SUMMARY OF THE INVENTION

The invention provides a specific method of a metallic decoration method of decorating decoration objects with decoration ink containing a silver β-ketocarboxylate. Also, the present invention provides a metallic decoration apparatus for decorating decoration objects by the above-mentioned metallic decoration method.

A metallic decoration method of the present invention includes a printing process of performing printing on a decoration object by ejecting decoration ink made by diluting a silver β-ketocarboxylate with a solvent from an inkjet head or a dispenser, and a heating process of heating the decoration object after the printing process, thereby decomposing the silver β-ketocarboxylate into metallic silver while vaporizing the solvent, thereby forming a metallic decoration layer, wherein, in the printing process, printing is performed on the decoration object while the decoration object is heated, and a heating temperature of the decoration object in the heating process is set so as to be equal to or higher than a heating temperature of the decoration object in the printing process.

In the metallic decoration method of the present invention, in the printing process, when printing is performed on the decoration object with the decoration ink made by diluting the silver β-ketocarboxylate with the solvent, the decoration object is heated. Therefore, according to the present invention, in the printing process, it is possible to vaporize the solvent contained in the decoration ink printed on the decoration object, thereby improving the viscosity of the decoration ink printed on the decoration object. Therefore, according to the present invention, in the printing process, it is possible to suppress bleeding of the decoration ink printed on the decoration object. As a result, it becomes possible to form a desired metallic decoration layer on the decoration object in the heating process after the printing process. Also, according to the present invention, since the heating temperature of the decoration object in the printing process is set so as to be equal to or lower than the heating temperature of the decoration object in the heating process, it is possible to set the heating temperature of the decoration object in the printing process such that the viscosity of the decoration ink contained in the inkjet head or the dispenser configured to eject the decoration ink does not increase and the inkjet head or the dispenser does not clog. Therefore, according to the present invention, even if the decoration object is heated in the printing process, it becomes possible to prevent clogging of the inkjet head or the dispenser. As described above, according to the metallic decoration method of the present invention, it is possible to form a desired metallic decoration layer while preventing clogging of the inkjet head or the dispenser.

It is preferable that the metallic decoration method of the present invention include an undercoat layer forming process of forming an undercoat layer for filling on the decoration object before the printing process and the metallic decoration layer be formed on the undercoat layer. According to this configuration, even in a case of performing decorating on a decoration object having permeability with respect to the decoration ink, such as fabric or paper, it is possible to prevent penetration of the decoration ink into the decoration object by an undercoat layer. Therefore, even in the case of performing decorating on a decoration object having permeability with respect to the decoration ink, such as fabric or paper, it becomes possible to form a desired metallic decoration layer on the decoration object.

In the present invention, in the heating process, it is preferable to heat the decoration object under a reduced-pressure environment. According to this configuration, it is possible to lower the boiling point of the solvent contained in the decoration ink in the heating process, and thus it is possible to vaporize the solvent contained in the decoration ink within a short time. Therefore, it is possible to finish the heating process within a short time.

It is preferable that the metallic decoration method of the present invention include an overcoat layer forming process of forming an overcoat layer so as to cover the metallic decoration layer after the heating process. According to this configuration, it is possible to prevent damage of the metallic decoration layer.

It is preferable that the metallic decoration method of the present invention include a second printing process of forming an ink layer on the metallic decoration layer after the heating process. According to this configuration, it is possible to form, for example, a color ink layer on the metallic decoration layer. Therefore, it is possible to improve the effect of decoration on the decoration object.

A metallic decoration apparatus for decorating a decoration object by the metallic decoration method of the present invention includes, for example, a first heater configured to heat the decoration object in the printing process, and a second heater configured to heat the decoration object in the heating process. In this case, it is possible to separately control the first heater and the second heater, and thus control on the temperature of the decoration object in the printing process and control on the temperature of the decoration object in the heating process become easy. Also, in this case, it is possible to consecutively perform the printing process and the heating process.

In the present invention, it is preferable that the metallic decoration apparatus include a third heater configured to heat the decoration object before the printing process. According to this configuration, even if the temperature of the first heater in the printing process is lowered, it is possible to suppress bleeding of the decoration ink in the printing process. In other words, according to this configuration, it is possible to lower the heating temperature of the decoration object in the printing process while suppressing bleeding of the decoration ink in the printing process. Therefore, it is possible to effectively prevent clogging of the inkjet head or the dispenser in the printing process.

As described above, according to the present invention, in the metallic decoration method of decorating a decoration object with the decoration ink containing the silver β-ketocarboxylate, it becomes possible to form a desired metallic decoration layer while preventing clogging of the inkjet head or the dispenser configured to eject the decoration ink. Also, according to the metallic decoration apparatus of the present invention, control on the temperature of a decoration object in the printing process and control on the temperature of the decoration object in the heating process become easy, and it becomes possible to consecutively perform the printing process and the heating process.

### BRIEF DESCRIPTION OF THE DRAWINGS

FIGS. 1A to 1C are schematic diagrams for explaining a metallic decoration method according to an embodiment of the present invention.

FIG. 2 is a schematic diagram for explaining the configuration of a metallic decoration apparatus for decorating a decoration object by the metallic decoration method shown in FIGS. 1A to 1C.

FIGS. 3A to 3D are schematic diagrams for explaining a metallic decoration method according to another embodiment of the present invention.

FIG. 4 is a schematic diagram for explaining a heating process according to a further embodiment of the present invention.

FIGS. 5A and 5B are schematic diagrams for explaining a metallic decoration method according to a still further embodiment of the present invention.

### DETAILED DESCRIPTION OF PREFERRED EMBODIMENTS

Hereinafter, embodiments of the present invention will be described with reference to the accompanying drawings.

(Metallic Decoration Method)

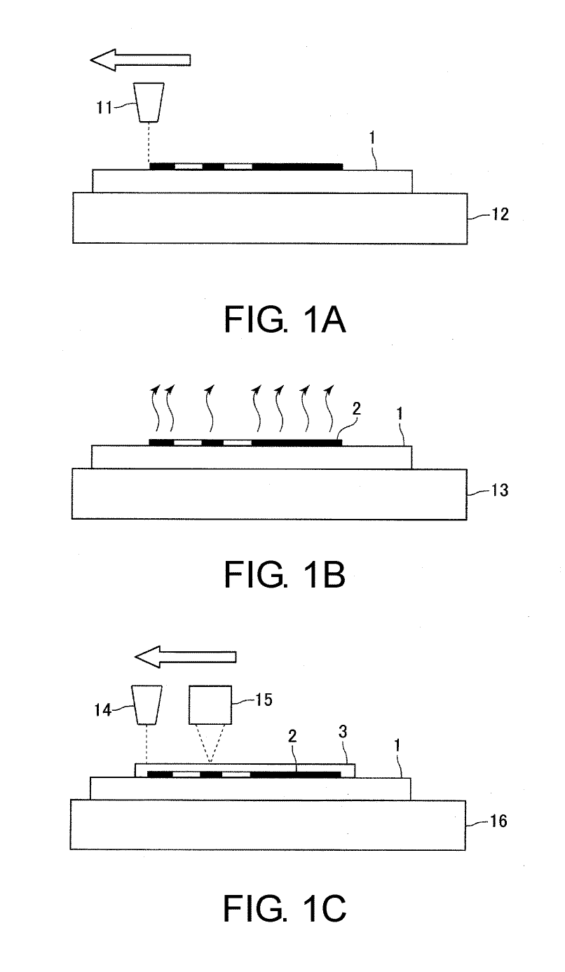

FIGS. 1A to 1C are schematic diagrams for explaining a metallic decoration method according to an embodiment of the present invention.

The metallic decoration method of the present embodiment is a method for producing a decoration object 1 having metallic luster like a mirror surface. In this metallic decoration method, the decoration object 1 is decorated with decoration ink containing a silver β-ketocarboxylate. The decoration object 1 of the present embodiment is a permeation object medium made of a material which does not have permeability with respect to the decoration ink (that is, a material which is not penetrated by the decoration ink). For example, the decoration object 1 is made of a plastic film, glass, a metal, coated paper, or the like. Also, the metallic decoration method of the present embodiment includes a printing process, a heating process which is performed after the printing process, and an overcoat layer forming process which is performed after the heating process.

In the printing process, printing is performed on the decoration object 1 with the decoration ink made by diluting the silver β-ketocarboxylate with a solvent. In this printing process, the decoration ink is ejected from an inkjet head 11 of an inkjet printer toward the decoration object 1. As shown in FIG. 1A, the inkjet head 11 is disposed above the decoration object 1, and moves above the decoration object 1. In the decoration ink, the silver β-ketocarboxylate has been dissolved in the solvent.

The silver β-ketocarboxylate contained in the decoration ink is organic acid silver disclosed in Japanese Patent No. 4452841 (organic acid silver bearing a β-ketocarbonyl group). For example, the silver β-ketocarboxylate is composed of at least one of silver isobutyrylacetate, silver benzoylacetate, silver acetoacetate, silver propionylacetate, silver α-methylacetoacetate, silver α-ethylacetoacetate, and silver α-n-butylacetoacetate. The decomposition temperature of the silver β-ketocarboxylate is, for example, in a range from about 60° C. to about 210° C. Since the silver β-ketocarboxylate is the known organic acid silver disclosed in Japanese Patent No. 4452841, a detailed description thereof will not be made.

Also, the solvent which is contained in the decoration ink is an organic solvent of amines, alcohols, ketones, ethers, glycols, sulfoxides, aromatic hydrocarbons, aliphatic hydrocarbons, and the like. Alternatively, the solvent which is contained in the decoration ink is water. Depending on the solvent, the viscosity, surface tension, and drying rate of the decoration ink are adjusted. The viscosity of the decoration ink of the present embodiment is set to such viscosity that the inkjet head 11 can eject the decoration ink, and is set, for example, within a range between 3 mPa·sec and 20 mPa·sec. Also, the decoration ink does not contain any binder and any dispersant. However, if a binder does not act with the silver β-ketocarboxylate, it may be contained in the decoration ink.

In a case where the solvent which is contained in the decoration ink is an amine, the solvent is, for example, propylamine, hexylamine, 2-ethylhexylamine, t-butylamine, octadecylamine, cyclohexylamine, 2-phenylethylamine, benzylamine, 2-bromobenzylamine, 2,3-dimethylcyclohexylamine, ethylenediamine, methylhexylamine, diethanolamine, methylbenzylamine, methylaminoethanol, dimethylaminoethanol, triethanolamine, dimethyloctadecylamine, dimethylcyclohexylamine, or 1-methyl-2-pyrrolidone.

Also, in a case where the solvent which is contained in the decoration ink is an alcohol, the solvent is, for example, methanol, ethanol, propanol, isopropanol, butoxyethanol, methoxyethanol, ethoxyethanol, butanol, pentanol, hexanol, octanol, nonanol, ethylene glycol, or glycerin, and in a case where the solvent which is contained in the decoration ink is a ketone, the solvent is, for example, 2,2-dimethyl-3-hexanone or cyclohexanone. Further, in a case where the solvent which is contained in the decoration ink is an ether, the solvent is, for example, acetoxymethoxypropane, phenylglycidylether, ethylene glycol glycidyl ether, or diethyl ether, and in a case where the solvent which is contained in the decoration ink is a sulfoxide, the solvent is, for example, dimethylsulfoxide.

Also, in the printing process, in order to vaporize the solvent contained in the decoration ink printed (applied) on the decoration object 1, thereby increasing the viscosity of the decoration ink, thereby suppressing bleeding of the decoration ink, printing is performed on the decoration object 1 with the decoration ink while the decoration object 1 is heated. In the printing process, heating on the decoration object 1 is performed by a heater 12 disposed below the decoration object 1. In order to prevent the inkjet head 11 from clogging, the heating temperature of the decoration object 1 in the printing process is set such that the viscosity of the decoration ink contained in the inkjet head 11 does not increase. Specifically, the heating temperature of the decoration object 1 in the printing process is set within a range from 30° C. to 70° C. In the present embodiment, the heating temperature of the decoration object 1 in the printing process is set to, for example, about 60° C.

In the heating process, the decoration object 1 subjected to the printing process is heated, whereby the solvent contained in the decoration ink is vaporized, and the silver β-ketocarboxylate is decomposed into metallic silver, whereby a metallic decoration layer 2 is formed. Specifically, in the heating process, the solvent contained in the decoration ink is completely vaporized, and the silver β-ketocarboxylate is thermally decomposed, thereby being metallized into metallic silver, and the metallic silver is fixed on the decoration object 1, whereby the metallic decoration layer 2 which is a silver coat is formed.

In the heating process, heating on the decoration object 1 is performed by a heater 13 disposed below the decoration object 1 (see FIG. 1B). The heating temperature of the decoration object 1 in the heating process is set to a temperature at which the silver β-ketocarboxylate is decomposed into metallic silver. Specifically, the heating temperature of the decoration object 1 in the heating process is set within a range from 60° C. to 180° C. Also, the heating temperature of the decoration object 1 in the heating process is set so as to be equal to or higher than the heating temperature of the decoration object 1 in the printing process. In the present embodiment, the heating temperature of the decoration object 1 in the heating process is set so as to be higher than the heating temperature of the decoration object 1 in the printing process, and is set to, for example, about 100° C. Also, in the heating process, heating on the decoration object 1 may be performed by an oven.

In the overcoat layer forming process, an overcoat layer 3 is formed so as to cover the metallic decoration layer 2. Specifically, in the overcoat layer forming process, for example, radical polymerization type or cationic polymerization type ultraviolet curing ink (UV ink) is ejected onto the metallic decoration layer 2, and the UV ink is irradiated with ultraviolet light, whereby the UV ink is hardened, whereby the overcoat layer 3 is formed. The UV ink which is ejected onto the metallic decoration layer 2 in the overcoat layer forming process is transparent clear ink. Also, in the overcoat layer forming process, as shown in FIG. 1C, the UV ink is ejected from an inkjet head 14 disposed above the decoration object 1 onto the metallic decoration layer 2. Immediately after that or after a predetermined time elapses, the UV ink is irradiated with ultraviolet light by an UV exposure unit 15 disposed above the decoration object 1. The inkjet head 14 and the UV exposure unit 15 move above the decoration object 1.

Also, in the overcoat layer forming process, the ink which is ejected onto the metallic decoration layer 2 may be solvent UV ink. In this case, it is possible to harden the solvent UV ink by heating the solvent UV ink by a heater 16 disposed below the decoration object 1 while irradiating the solvent UV ink with ultraviolet light by the UV exposure unit 15. Also, the ink which is ejected onto the metallic decoration layer 2 may be solvent ink, latex ink, or water-based ink (water-based pigment ink or water-based dye ink), or the like. In this case, the ink may be heated by the heater 16, thereby being hardened. Also, in the overcoat layer forming process, the ink which is ejected onto the metallic decoration layer 2 may not be clear ink. In other words, in the overcoat layer forming process, the ink which is ejected onto the metallic decoration layer 2 may be color ink.

(Metallic Decoration Apparatus)

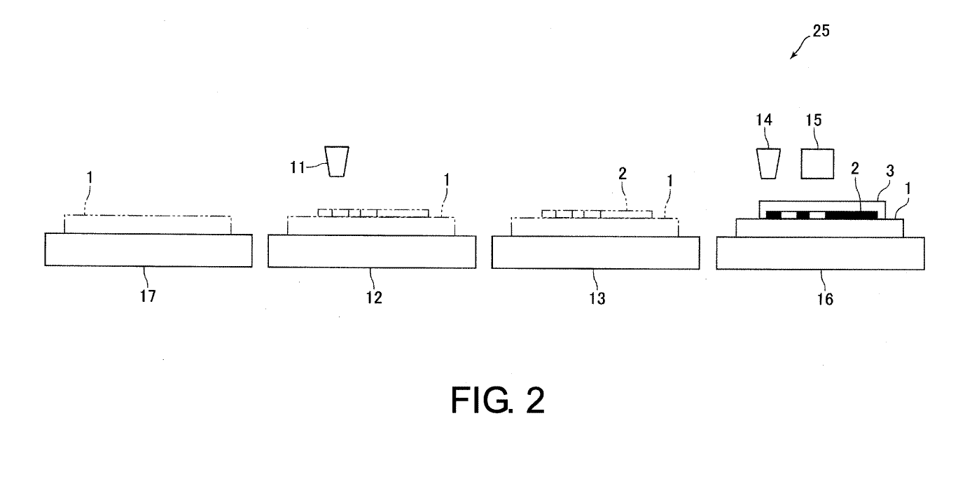

FIG. 2 is a schematic diagram for explaining the configuration of a metallic decoration apparatus 25 for decorating a decoration object 1 by the metallic decoration method shown in FIGS. 1A to 1C.

In a case of decorating a decoration object 1 by the above-described metallic decoration method, if the heating time of the decoration object 1 in the heating process is short, for example, the printing process, the heating process, and the overcoat layer forming process are consecutively performed by the metallic decoration apparatus 25 shown in FIG. 2. The metallic decoration apparatus 25 includes a mechanism (not shown in FIG. 2) for conveying the decoration object 1, and in the conveyance direction of the decoration object 1, the inkjet head 11 and the heater 12, the heater 13, the inkjet head 14, and the UV exposure unit 15 and the heater 16 are disposed in the order.

Also, the metallic decoration apparatus 25 includes a heater 17 for heating the decoration object 1 before the printing process. In other words, the metallic decoration apparatus 25 includes the heater 17 for preliminarily heating the decoration object 1. In this metallic decoration apparatus 25, the heater 12 is a first heater for heating the decoration object 1 in the printing process, and the heater 13 is a second heater for heating the decoration object 1 in the heating process. Also, the heater 17 is a third heater for heating the decoration object 1 before the printing process. However, the metallic decoration apparatus 25 may not include the heater 17.

(Main Effects of Present Embodiment)

As described above, according to the present embodiment, in the printing process, when printing is performed on the decoration object 1 with the decoration ink made by diluting the silver β-ketocarboxylate with the solvent, the decoration object 1 is heated, whereby the solvent contained in the decoration ink printed on the decoration object 1 is vaporized such that the viscosity of the decoration ink increases, whereby bleeding of the decoration ink is suppressed. Therefore, according to the present embodiment, it becomes possible to suppress bleeding of the decoration ink printed on the decoration object 1 in the printing process, and as a result, it is possible to form a desired metallic decoration layer 2 on the decoration object 1 in the heating process after the printing process. Also, according to the present embodiment, the heating temperature of the decoration object 1 in the printing process is set so as to be lower than the heating temperature of the decoration object 1 in the heating process, and in order to prevent the inkjet head 11 from clogging, the heating temperature of the decoration object 1 in the printing process is set such that the viscosity of the decoration ink contained in the inkjet head 11 does not increase. Therefore, according to the present embodiment, it is possible to prevent clogging of the inkjet head 11. From the above description, according to the present embodiment, it is possible to form a desired metallic decoration layer 2 while preventing clogging of the inkjet head 11. Also, according to the present embodiment, since the overcoat layer 3 is formed on the metallic decoration layer 2 so as to cover the metallic decoration layer 2, it is possible to prevent damage of the metallic decoration layer 2.

In the present embodiment, the metallic decoration apparatus 25 includes the heater 12 for heating the decoration object 1 in the printing process, and the heater 13 for heating the decoration object 1 in the heating process. For this reason, according to the present embodiment, it becomes possible to separately control the heater 12 and the heater 13. As a result, control on the temperature of the decoration object 1 in the printing process and control on the temperature of the decoration object 1 in the heating process become easy. Also, it becomes possible to consecutively perform the printing process and the heating process. Also, since the metallic decoration apparatus 25 of the present embodiment includes the heater 17 for preliminarily heating the decoration object 1 before the printing process, even if the temperature of the heater 12 is lowered in the printing process, it is possible to suppress bleeding of the decoration ink in the printing process. In other words, according to the present embodiment, it is possible to lower the heating temperature of the decoration object 1 in the printing process while suppressing bleeding of the decoration ink in the printing process. Therefore, it is possible to effectively prevent clogging of the inkjet head 11 in the printing process.

(First Modification of Metallic Decoration Method)

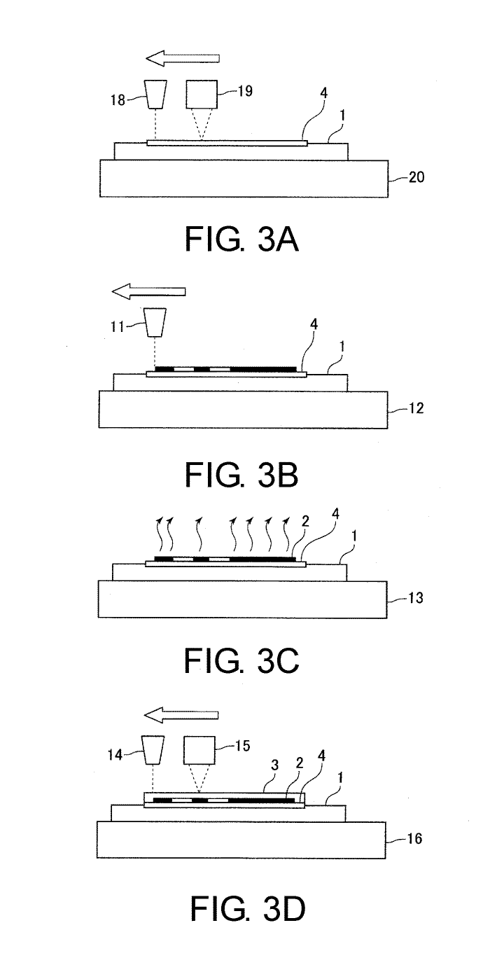

FIGS. 3A to 3D are schematic diagrams for explaining a metallic decoration method according to another embodiment of the present invention. In FIGS. 3A to 3D, components identical to those in the above-described embodiment are denoted by the same reference symbols.

In the above-described embodiment, the decoration object 1 is an impermeable medium which does not have permeability with respect to the decoration ink. However, the decoration object 1 may be a permeable medium having permeability with respect to the decoration ink. For example, the decoration object 1 may be fabric or paper, or may be made of a porous material. In this case, before the printing process, in order to prevent permeation of the decoration ink into the decoration object 1, an undercoat layer 4 (see FIGS. 3A to 3D) for filling is formed on the decoration object 1 (an undercoat layer forming process). Then, on the undercoat layer 4, the metallic decoration layer 2 is formed.

In the undercoat layer forming process, for example, UV ink is ejected onto at least a portion of the decoration object 1 on which the metallic decoration layer 2 will be formed, and the UV ink is irradiated with ultraviolet light, whereby the UV ink is hardened, whereby the undercoat layer 4 is formed. In the undercoat layer forming process, as shown in FIG. 3A, the UV ink is ejected from an inkjet head 18 disposed above the decoration object 1. Immediately after that or after a predetermined time elapses, the UV ink is irradiated with ultraviolet light by an UV exposure unit 19 disposed above the decoration object 1. The inkjet head 18 and the UV exposure unit 19 move above the decoration object 1.

Also, in the undercoat layer forming process, the ink which is ejected onto the decoration object 1 may be solvent UV ink. In this case, while the solvent UV ink is irradiated with ultraviolet light by the UV exposure unit 19, the solvent UV ink is heated by a heater 20 disposed below the decoration object 1, thereby being hardened. Also, in the undercoat layer forming process, the ink which is ejected onto the decoration object 1 may be solvent ink, latex ink, water-based ink, or the like. In this case, the ink is heated by the heater 20, thereby being hardened.

After the undercoat layer forming process, similarly in the above-described embodiment, the printing process, the heating process, and the overcoat layer forming process are sequentially performed. After the undercoat layer forming process, in the printing process, as shown in FIG. 3B, while the decoration object 1 is heated, printing is performed on the decoration object 1 by ejecting the decoration ink from the inkjet head 11 onto the undercoat layer 4. Also, similarly in the above-described embodiment, after the metallic decoration layer 2 is formed in the heating process (see FIG. 3C), in the overcoat layer forming process, the overcoat layer 3 is formed (see FIG. 3D).

According to this modification, even in the case of performing decoration on the decoration object 1 having permeability with respect to the decoration ink, it is possible to prevent penetration of the decoration ink into the decoration object 1 by the undercoat layer 4. Therefore, even in the case of performing decoration on the decoration object 1 having permeability with respect to the decoration ink, in the heating process, it is possible to surely vaporize the solvent contained in the decoration ink. As a result, it becomes possible to form a desired metallic decoration layer 2 on the decoration object 1 in the heating process.

(Second Modification of Metallic Decoration Method)

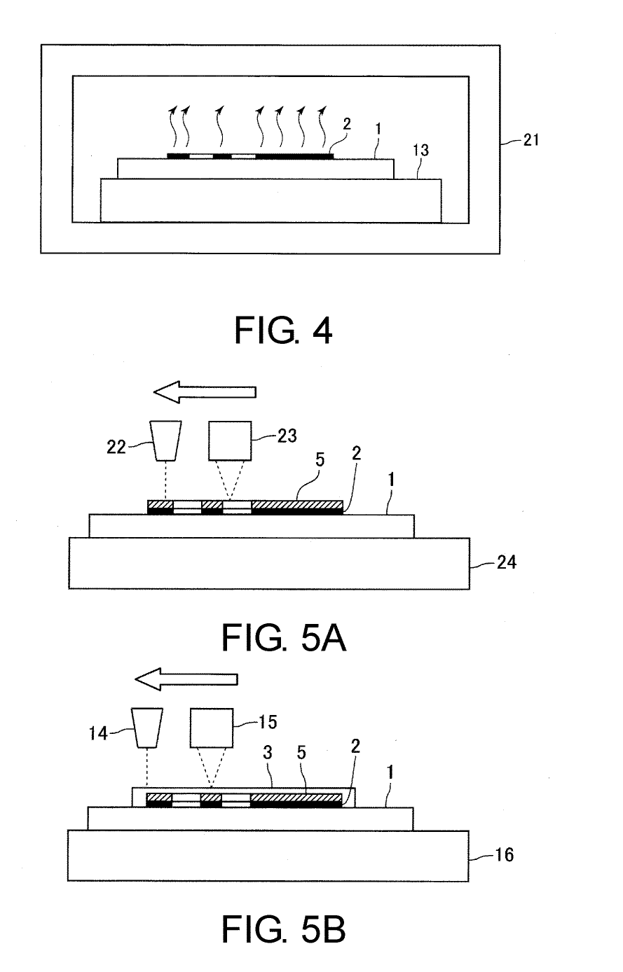

FIG. 4 is a schematic diagram for explaining a heating process according to a further embodiment of the present invention. In FIG. 4, components identical to the above-described embodiment are denoted by the same reference symbols.

In the heating process of the above-described embodiment, the decoration object 1 may be heated under a reduced-pressure environment. For example, as shown in FIG. 4, in the heating process, it is possible to dispose the decoration object 1 mounted on the heater 13 inside a vacuum chamber (a reduced-pressure chamber) 21, and heat the decoration object 1 under a reduced-pressure environment. Alternatively, in the heating process, it is possible to dispose the decoration object 1 inside a vacuum oven and heat the decoration object 1 under a reduced-pressure environment. Similarly, in the modification shown in FIGS. 3A to 3D, the decoration object 1 may be heated under a reduced-pressure environment. In this case, in the heating process, it becomes possible to lower the boiling point of the solvent contained in the decoration ink, and thus it becomes possible to completely vaporize the solvent contained in the decoration ink within a short time. Therefore, it becomes possible to finish the heating process within a short time.

However, in this modification, before the overcoat layer forming process is performed, it is required to move the decoration object 1 from the inside of the vacuum chamber 21 (or the vacuum oven) to a position lower than the inkjet head 14 and the UV exposure unit 15. For this reason, in the overcoat layer forming process, there is a fear that misalignment of the overcoat layer 3 with the metallic decoration layer 2 may occur. Therefore, in this modification, it is preferable to perform the heating process and the overcoat layer forming process in a state where the decoration object 1 is fixed by a predetermined fixing jig, thereby preventing misalignment of the overcoat layer 3 with the metallic decoration layer 2. In this case, the fixing jig may have a heating function such that the fixing jig functions as a heater. Also, it is possible to form marks for alignment such as register masks on the metallic decoration layer 2, and perform aligning in the overcoat layer forming process by detecting the marks, thereby preventing misalignment of the overcoat layer 3 with the metallic decoration layer 2.

(Third Modification of Metallic Decoration Method)

FIGS. 5A and 5B are schematic diagrams for explaining a metallic decoration method according to a still further embodiment of the present invention. In FIGS. 5A and 5B, components identical to those of the above-described embodiment are denoted by the same reference symbols.

In the above-described embodiment, after the heating process and before the overcoat layer forming process, a second printing process of forming an ink layer 5 of color ink on the metallic decoration layer 2 may be performed. In the second printing process, for example, UV ink is ejected onto at least a portion having the metallic decoration layer 2 formed thereon, and the UV ink is irradiated with ultraviolet light, whereby the UV ink is hardened, whereby the ink layer 5 is formed. In the second printing process, as shown in FIG. 5A, the UV ink is ejected from an inkjet head 22 disposed above the decoration object 1. Immediately after that or after a predetermined time elapses, ultraviolet light is radiated toward the UV ink by an UV exposure unit 23 disposed above the decoration object 1. The inkjet head 22 and the UV exposure unit 23 move above the decoration object 1.

Also, in the second printing process, the ink which is ejected onto the decoration object 1 may be a solvent UV ink. In this case, while the solvent UV ink is irradiated with ultraviolet light by the UV exposure unit 23, the solvent UV ink is heated by a heater 24 disposed below the decoration object 1, thereby being hardened. Also, in the second printing process, the ink which is ejected onto the decoration object 1 may be solvent ink, latex ink, water-based ink, or the like. In this case, the ink is heated by the heater 24, thereby being hardened.

After the second printing process, similarly in the above-described embodiment, the overcoat layer forming process is performed. After the second printing process, in the overcoat layer forming process, the UV ink or the like is ejected from the inkjet head 14 onto the ink layer 5, whereby the overcoat layer 3 is formed so as to cover the metallic decoration layer 2 and the ink layer 5 as shown in FIG. 5B. In this modification, since it is possible to form the ink layer 5 of the color ink on the metallic decoration layer 2, it is possible to improve the effect of decoration on the decoration object 1.

### OTHER EMBODIMENTS

In the above-described embodiment, in the printing process, the decoration ink is ejected from the inkjet head 11. However, in the printing process, the decoration ink may be ejected from a dispenser. Also, in the overcoat layer forming process, the ink may be ejected from a dispenser, and in the undercoat layer forming process, the ink may be ejected from a dispenser, and in the second printing process, the ink may be ejected from a dispenser. Also, in the overcoat layer forming process, the undercoat layer forming process, and the second printing process, printing may be performed in a printing system other than an inkjet head system and a dispenser system.

In the above-described embodiment, the heater 12 for the printing process and the heater 12 for the heating process are separately provided. However, the heater 12 for the printing process and the heater 13 for the heating process may be a common heater. Also, two or more arbitrary heaters which are selected from the heaters 12, 13, 16, 20, and 24 may be a common heater. Also, in the above-described embodiment, the inkjet head 11 for the printing process and the inkjet head 14 for the overcoat layer forming process are separately provided. However, the inkjet head 11 and the inkjet head 14 may be a common inkjet head. Also, two or more arbitrary inkjet heads which are selected from the inkjet heads 11, 14, 18, and 22 may be a common inkjet head. Similarly, two or more arbitrary UV exposure units which are selected from the UV exposure units 15, 19, and 23 may be a common UV exposure unit.

In the above-described embodiment, before the overcoat layer forming process, the heating process is performed. However, the heating process may be divided into processes which are performed before and after the overcoat layer forming process, respectively. Specifically, before the overcoat layer forming process, it is possible to perform a preliminarily heating process of preliminarily heating the decoration ink to such an extent that the decoration ink does not bleed when the overcoat layer 3 is formed, and after the overcoat layer forming process, it is possible to perform a re-heating process of completely vaporizing the solvent contained in the decoration ink while thermally decomposing the silver β-ketocarboxylate, thereby metallizing the silver β-ketocarboxylate, thereby forming the metallic decoration layer 2. In other words, the heating process may be divided into the preliminarily heating process and the re-heating process. In this case, it becomes possible to reduce the heating time of the decoration object 1 in the preliminarily heating process, and thus it becomes possible to consecutively perform the processes to the overcoat layer forming process. Also, even in this case, the heating temperature of the decoration object 1 in the preliminarily heating process and the heating temperature of the decoration object 1 in the re-heating process are set so as to be equal to or higher than the heating temperature of the decoration object 1 in the printing process.

What is claimed is:

1. A metallic decoration method comprising:
a printing process of performing printing on a decoration object by ejecting decoration ink made by diluting a silver β-ketocarboxylate with a solvent from an inkjet head or a dispenser; and
a heating process of heating the decoration object after the printing process, thereby decomposing the silver β-ketocarboxylate into metallic silver while vaporizing the solvent, thereby forming a metallic decoration layer,
wherein, in the printing process, printing is performed on the decoration object while the decoration object is heated, and
a heating temperature of the decoration object in the heating process is set so as to be equal to or higher than a heating temperature of the decoration object in the printing process.

2. The metallic decoration method according to claim 1, further comprising:
before the printing process, an undercoat layer forming process of forming an undercoat layer for filling on the decoration object,
wherein the metallic decoration layer is formed on the undercoat layer.

3. The metallic decoration method according to claim 1, wherein:
in the heating process, the decoration object is heated under a reduced-pressure environment.

4. The metallic decoration method according to claim 2, wherein:
in the heating process, the decoration object is heated under a reduced-pressure environment.

5. The metallic decoration method according to claim 1, further comprising:
after the heating process, an overcoat layer forming process of forming an overcoat layer so as to cover the metallic decoration layer.

6. The metallic decoration method according to claim 1, further comprising:
after the heating process, a second printing process of forming an ink layer on the metallic decoration layer.

7. A metallic decoration apparatus comprising:
an inkjet head or a dispenser configured to eject decoration ink made by diluting a silver β-ketocarboxylate with a solvent, thereby performing printing on a decoration object;
a first heater configured to heat the decoration object while printing is performed on the decoration object; and
a second heater configured to heat the decoration object, thereby vaporizing the solvent in order to decompose the silver β-ketocarboxylate printed on the decoration object into metallic silver, thereby forming a metallic decoration layer.

8. The metallic decoration apparatus according to claim 7, further comprising:
a third heater configured to heat the decoration object before printing on the decoration object.
